(19) United States
(12) Patent Application Publication
(10) Pub. No.: US 2018/0306951 A1
(43) Pub. Date: Oct. 25, 2018

(54) APPARATUS AND METHOD FOR SIGNAL ENHANCEMENT OF IR DETECTORS

(71) Applicant: LumaSense Technologies Holdings, Inc., Santa Clara, CA (US)

(72) Inventors: Nader Mahvan, Santa Clara, CA (US); David Diepersloot, Santa Clara, CA (US)

(73) Assignee: LumaSense Technologies Holdings, Inc., Santa Clara, CA (US)

(21) Appl. No.: 15/957,220

(22) Filed: Apr. 19, 2018

Related U.S. Application Data
(60) Provisional application No. 62/489,388, filed on Apr. 24, 2017.

(51) Int. Cl. G02B 5/09; G01N 21/3504

(52) U.S. Cl. CPC G02B 5/09; G01N 2201/0636; G01N 21/3504

(57) ABSTRACT

A reflector may include an exterior wall, an interior space, one or more interior walls, each interior wall having two ends, a proximal end, and a distal end. Each end of an interior wall may be attached to the exterior wall or to a different interior wall. The interior walls may divide the interior space into two or more sections. The proximal end and the distal end of the reflector may be open. The exterior wall and the interior walls may be configured to reflect light that contacts the exterior wall or interior walls through the distal end of the reflector.

### BACKGROUND

Non-dispersive infrared sensors, also referred to as NDIR sensors and infrared sensors herein, detect wavelengths of infrared or optical light which has been transmitted through a gas. The detection of particular wavelengths may allow the gas through which the light is transmitted to be identified because different gases transmit different wavelengths of light. The Beer-Lambert law governs the wavelengths which are detected by an infrared sensor.

FIG. 1 shows a cross-section view of an infrared sensor 50. The infrared sensor 50 may have a proximal end 54 and a distal end 56. The infrared sensor 50 may include a tube 52. An infrared or optical light source 62 may be located within the tube 52 at the proximal end 54 of the infrared sensor 50. One or more detectors 58 may be located within the tube 52 at the distal end 56 of the infrared sensor 50. The infrared sensor 50 may optionally include a filter 64 which may be located within the tube 52 at the distal end 56 of the infrared sensor 50, proximal to the detector 58. A sample chamber 66 may be located within the tube 52, between the light source 62 and the detector 58 or the filter 64. The sample chamber 66 may include a gas inlet 68 and a gas outlet 70.

The infrared sensor 50 may be used to identify a gas or to determine the concentration of a particular gas within a mixture of gases. The gas to be analyzed may be flowed into the sample chamber 66 through the gas inlet 68. The gas may flow out of the sample chamber 66 through the gas outlet 70. During measurements, a constant amount of gas may be kept within the sample chamber 66 by flowing gas into and out of the chamber at equal rates.

The light source 62 may emit optical or infrared light 60a, 60b, and 60c. The light 60a, 60b, and 60c, may travel through the gas in the sample chamber 66. The gas may absorb some wavelengths of the light while transmitting other wavelengths of the light. Light having the wavelengths that are transmitted may reach detector 58. The detector 58 may measure the wavelength of the light. The measured wavelength may be used to identify the gas. If the infrared sensor 50 includes on filter 64, the filter 64 may filter desired wavelengths of the light to prevent those wavelengths from reaching the detector 58.

The accuracy of the wavelength measurement made by the detector 58 and therefore the ability of the infrared sensor 50 to identify the gas depend in part on the amount of light rays 60a, 60b, and 60c which reach the detector 58. The light rays may reflect off of the inside of the tube 52 and not reach the detector 58. Having too few light rays 60a, 60b, and 60c reach the detector decreases the magnitude of the signal measured by the detector, and therefore decreases the signal to noise ratio of the measurement. Unfortunately, a lower signal to noise ratio makes the measurement of the wavelength of interest by the detector less accurate.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, the present disclosure relates to a reflector which may include an exterior wall, an interior space, one or more interior walls, each interior wall having two ends, a proximal end, and a distal end. Each end of an interior wall may be attached to the exterior wall or to a different interior wall. The interior walls may divide the interior space into two or more sections. The proximal end and the distal end of the reflector may be open. The exterior wall and the interior walls may be configured to reflect light that contacts the exterior wall or interior walls through the distal end of the reflector.

In another aspect, the present disclosure relates to an infrared device which may include a tube having a proximal end and a distal end, a light source disposed at the proximal end of the tube, one or more detectors disposed at the distal end of the tube, a filter disposed between the light source and the one or more detectors, and a reflector. The reflector may include an exterior wall, an interior space, one or more interior walls, each interior wall having two ends, a proximal end, and a distal end. Each end of an interior wall may be attached to the exterior wall or to a different interior wall. The interior walls may divide the interior space into two or more sections. The proximal end and the distal end of the reflector may be open. The exterior wall and the interior walls may be configured to reflect light that contacts the exterior wall or interior walls through the distal end of the reflector.

In another aspect, the present disclosure relates to a method of constructing an infrared device which may include the step of disposing a reflector intermediate a light source and one or more detectors. The reflector may include an exterior wall, an interior space, one or more interior walls, each interior wall having two ends, a proximal end, and a distal end. Each end of an interior wall may be attached to the exterior wall or to a different interior wall. The interior walls may divide the interior space into two or more sections. The proximal end and the distal end of the reflector may be open. The exterior wall and the interior walls may be configured to reflect light that contacts the exterior wall or interior walls through the distal end of the reflector. The distal end of the reflector may be proximate the one or more detectors.

Other aspects and advantages will be apparent from the following description and the appended claims.

### BRIEF DESCRIPTION OF DRAWINGS

FIG. 1 is a perspective view of a prior art infrared sensor.

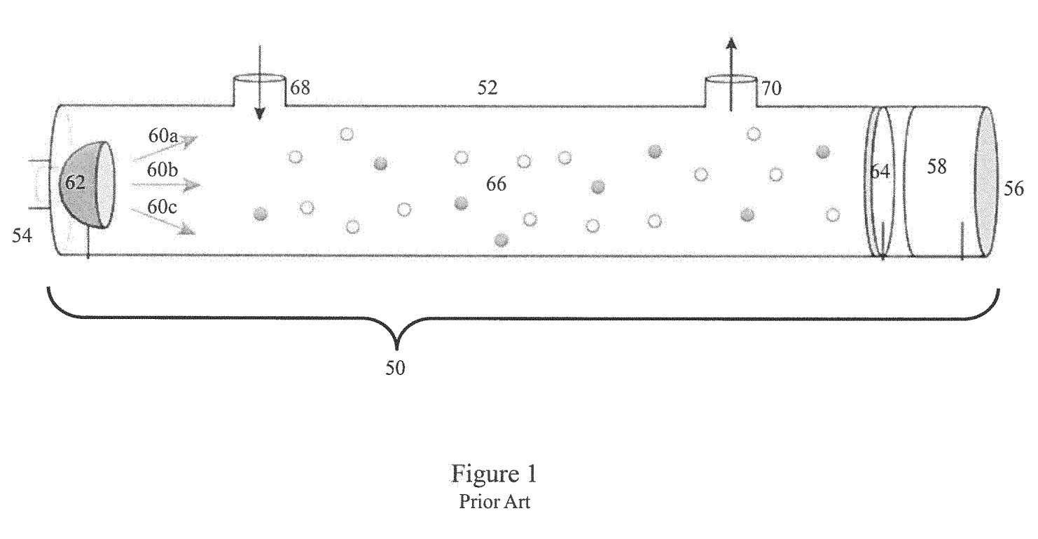

FIG. 2a is a perspective view of a reflector in accordance with the present disclosure.

FIG. 2b is a perspective view of a reflector in accordance with the present disclosure.

FIG. 3 is a cross-section view of an infrared sensor in accordance with the present disclosure.

FIG. 4 is a perspective view of an infrared sensor in accordance with the present disclosure.

FIG. 5 is a perspective view of a reflector in accordance with the present disclosure.

FIG. 6 is a graph of experimental data collected from an infrared sensor in accordance with the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments disclosed herein may generally relate to a reflector for an infrared sensor, an infrared sensor including a reflector, a method of manufacturing a reflector, and a method of manufacturing an infrared sensor including a reflector.

As noted above, a low signal to noise ratio provides for less accurate measurement than does a high signal to noise ratio. The reflectors described in embodiments herein may be used to increase the signal to noise ratio, providing for an increased accuracy. In general, reflectors described herein may increase the signal to noise ratio by increasing the strength of the signal measured by the detectors with which the reflectors are used. The reflectors may increase the signal strength by directing, focusing, or reflecting infrared and/or optical light onto the detectors. Light rays in regions where a beam of light happens to be most intense may be wasted in an infrared sensor without a reflector. The reflector may direct, focus, or reflect the light rays in such regions onto the detectors. The infrared and/or optical light the reflectors reflect onto the detectors may be light that would not have contacted the detectors otherwise. The reflectors described herein may include any component having a reflective surface that reflects infrared and/or optical light onto a detector.

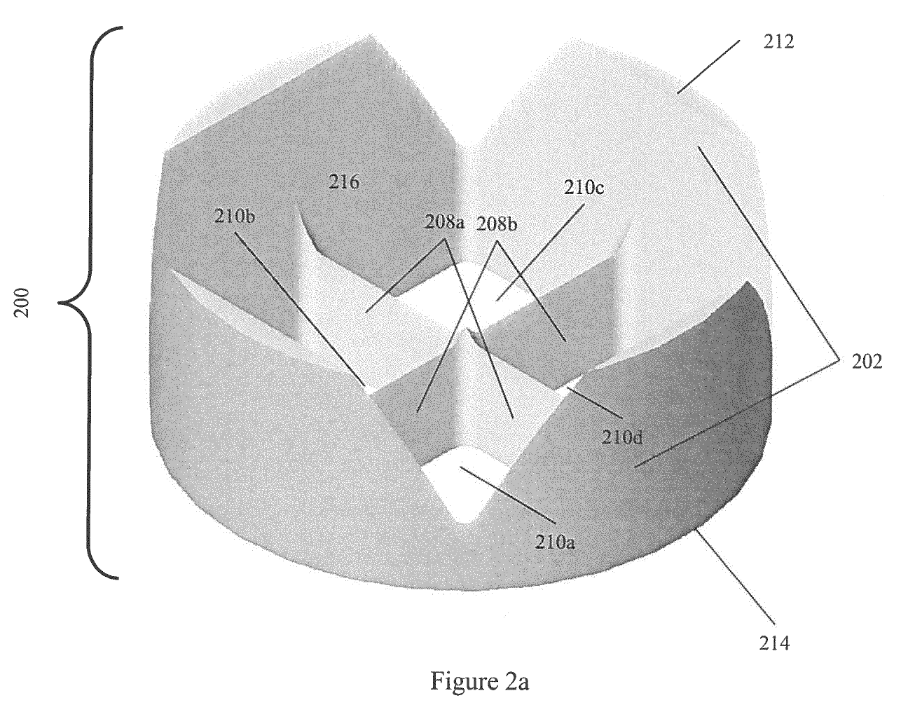

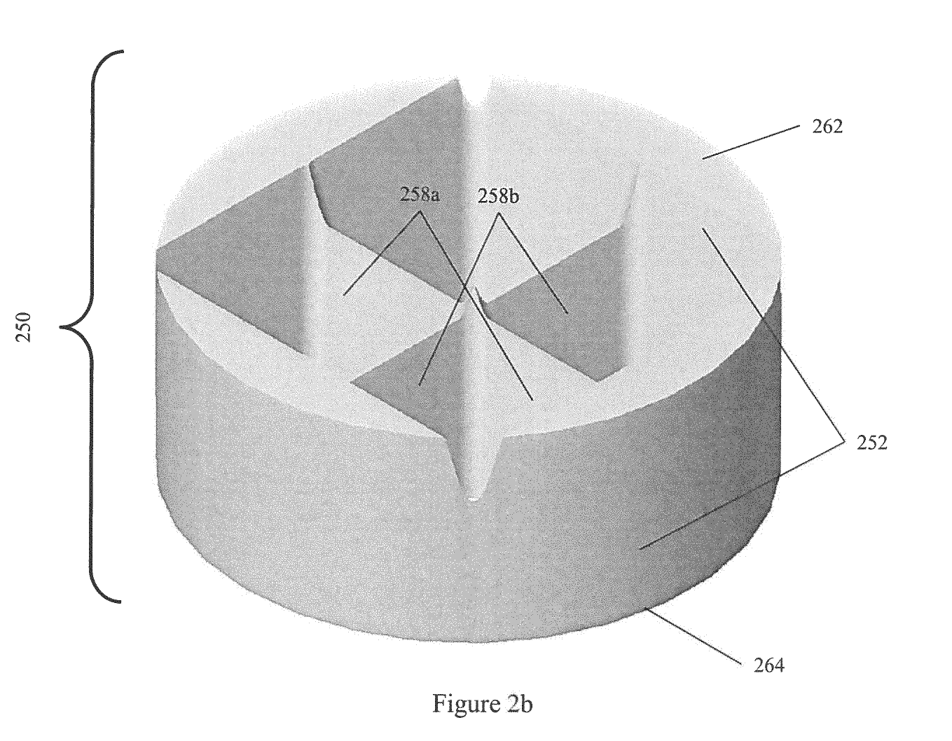

FIG. 2a illustrates a reflector 200 in accordance with embodiments herein. The reflector 200 may include an exterior wall 202. The reflector 200 may include an interior space 216 within the exterior wall 202. In some embodiments, the exterior wall 202 may be cylindrical. In some embodiments, the exterior wall 202 may have any shape. The shape of the exterior wall 202 may allow the reflector 200 to fit inside an infrared sensor.

The reflector 200 may include one or more interior walls 208a and 208b. Each interior wail 208a and 208b may have two ends. In some embodiments, the reflector 200 may have any number of interior walls 208a and 208b. Each end of an interior wall 208a and 208b may be attached to the exterior wall 200 or to a different interior wall 208a and 208b. In some embodiments, one or more of the interior walls 208a and 208b may be straight. In some embodiments, one or more of the interior walls 208a and 208b may be curved. In some embodiments, one or more of the interior walls 208a and 208b may have a straight portion and a curved portion.

In some embodiments, as shown in FIG. 2a, the reflector 200 may have two interior walls 208a and 208b. The two interior walls 208a and 208b may intersect at a right angle. The two interior walls 208a and 208b may be straight. The ends of the two interior walls 208a and 208b may be attached to the exterior wall 202.

The interior walls 208a and 208b may divide the interior space 216 of the reflector 200 into two or more sections. In some embodiments, as illustrated in FIG. 2a, the interior walls 208a and 208b may divide the interior space 216 into four sections 210a, 210b, 210c, and 210d. The four sections 210a, 210b, 210c, and 210d may each have an approximately square cross-section. The approximately square cross-section may have rounded corners. In some embodiments the sections may have any cross-section known in the art.

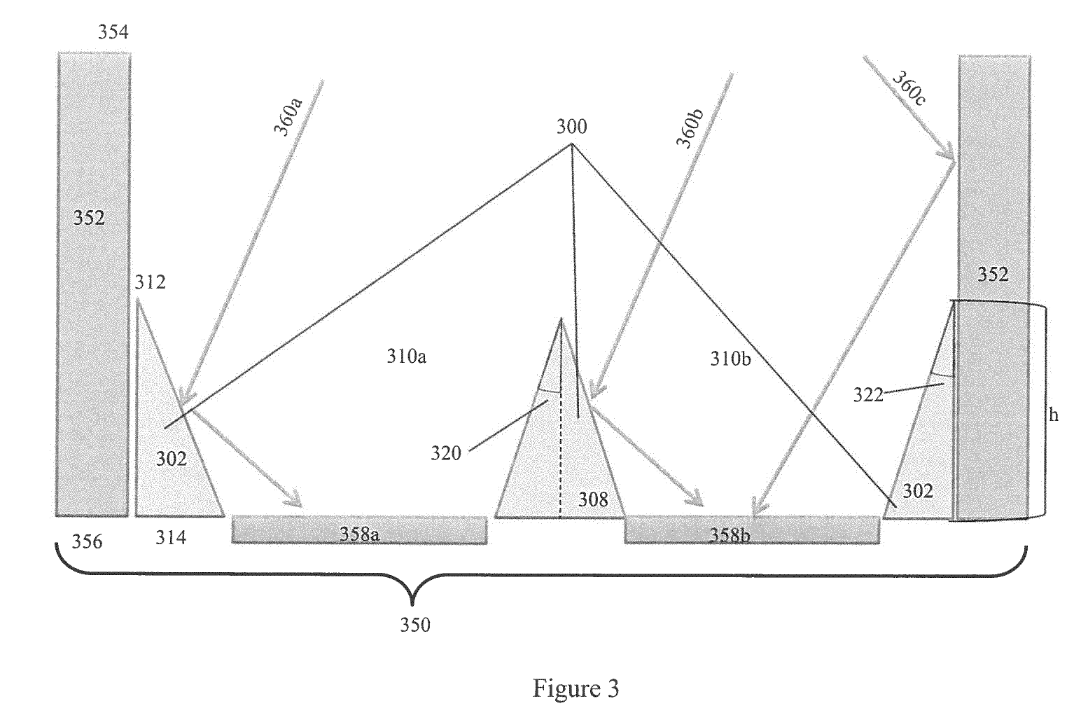

The reflector 200 may include a proximal end 212 and a distal end 214. The proximal end 212 and the distal end 214 may be open. The exterior wall 202 may extend from the distal end 214 of the reflector 200 to the proximal end 212 of the reflector 200. As shown in FIG. 3, the reflector 200 may have a height h, measured as the distance from the distal end 214 to the proximal end 212. The interior walls 208a and 208b may extend a height less than or equal to h from the distal end 214 of the reflector. In some embodiments, the height of the interior walls 208a and 208b may be between 0.15 h and 0.85 h. In some embodiments the height of the interior walls 208a and 208b may be between 0.3 h and 0.7 h. In some embodiments, the height of the interior walls 208a and 208b may be about 0.5 h. In some embodiments, the height of the interior walls 208a and 208b may be about h. For example, FIG. 2a illustrates an embodiment of a reflector 200 in which the interior walls have a height of about 0.4 h. The interior walls 208a and 208b or a portion thereof and the exterior wall 202 or a portion thereof may be tapered from the distal end 214 to the proximal end 212. The interior walls 208a and 208b may be tapered from a maximum thickness at the distal end 214 to a minimum thickness at the proximal end 212. The minimum thickness may be near zero. In some embodiments, the interior walls 208a and 208b may form an acute angle with a vertical axis aligned with the proximal end of the interior walls 208a and 203b. (See angle 320 in FIG. 3.) In some embodiments, the angle may be between five degrees and twenty degrees. In some embodiments, the angle may be approximately ten degrees. In some embodiments, the angle may be greater than twenty degrees. In some embodiments, the angle may be less than five degrees. In some embodiments, the angle formed by all interior walls 208a and 208b may be the same. In some embodiments, the tapered interior wails 208a and 208b may include regions that are slanted at different angles along the height of the tapered interior walls 208a and 208b. For example, the tapered interior walls 208a and 208b may include a convex curve between the point of maximum thickness at the distal end 214 to the point of minimum thickness at the proximal end 212. In some embodiments, the interior walls 208a and 208b may have any angle or profile.

The shape of the interior walls 208a and 208b may allow as much light as possible that contacts the sides of the interior walls 208a and 208b to be reflected through the openings formed by the sections 210a, 210b, 210c, and 210d at the distal end of the reflector 200. For example, having a minimum thickness at the proximal end 212 near zero may decrease the amount of light that strikes a proximal surface of the interior walls 208a and 208b and is reflected back away from the detectors. Having a minimum thickness at the proximal end 212 near zero may also cause the light to instead strike the sides of the interior walls 208a and 208b and be directed or reflected towards a detector located proximate the distal end 214 of the reflector 200. The shape of the interior walls 208a and 208b increase the amount of light that is reflected onto a detector located proximate the distal end 214 of the reflector 200. For example, the shape of the interior walls 208a and 208b may be such that light reflects off the interior walls 208a and 208b towards the distal end of the reflector 200.

The exterior wall 202 may similarly be tapered from a maximum thickness at the distal end 214 to a minimum thickness at the proximal end 212. The minimum thickness may be near zero. In some embodiments, the exterior wall 202 may form an acute angle with a vertical axis aligned with the proximal end of the exterior wall 202. (See angle 322 in FIG. 3.) In some embodiments, the angle may be between five degrees and twenty degrees. In some embodiments, the angle may be approximately ten degrees. In some embodiments, the angle may be greater than twenty degrees. In some embodiments, the angle may be less than five degrees. In some embodiments, the angle formed by the exterior wall 202 may be the same as the angle formed by the interior walls 208a and 208b. For example, FIG. 2a shows an embodiment of the reflector 200 in which the interior walls 208a and 208b and the exterior wall 202 form angles of twenty degrees with the vertical axes described above. In some embodiments, the tapered exterior wall 202 may include regions that are slanted at different angles along the height of the tapered exterior wall 202. For example, the tapered exterior wall 202 may include a convex curve between the point of maximum thickness at the distal end 214 to the point of minimum thickness at the proximal end 212. In some embodiments, the exterior wall 202 may have any angle or profile.

The outer side of the exterior wall 202 may have a cylindrical cross-section. The sections 210a, 210b, 210c, and 210d of the reflector 200 may have approximately square cross-sections at the distal end 214 of the reflector 200. One corner of the square cross-section may be formed entirely by the exterior wall 202. One corner of the square cross-section may be formed by the intersection of two interior walls 208a and 208b. Two corners of the square cross-section may be formed by the intersection of the exterior wall 202 and, respectively, one of the interior walls 208a or 208b. The exterior wall 202 may not have a constant circumferential thickness.

The exterior wall 202 may be tapered at a constant angle. In some embodiments, the exterior wall 202 may not have a constant height. The greatest height of the exterior wall 202 may be h. The height of the exterior wall 202 may be smallest proximate the corner of each section formed entirely by the exterior wall 202. The height of the exterior wall 202 may be greatest proximate the corners of the section formed by the intersection of the exterior wall 202 and one of the interior walls 208a or 208b. The height of the exterior wall 202 may taper between the points at which the height is greatest and the points at which the height is smallest.

The varying height and thickness of the exterior wall 202 may create “valleys” near the corner of each section which is formed entirely by the exterior wall 202. At a single height, the exterior wall 202 may have a non-constant thickness. The shape of the exterior wall 202 may allow as much light as possible to contact the sides of the exterior wall 202. For example, having a minimum thickness at the proximal end 212 near zero may decrease the amount of light that strikes a proximal surface of the exterior wall 202 and may cause the light to instead strike the sides of exterior wall 202. The shape of the exterior wall, including the variations in height and the “valleys,” may increase the amount of light that is reflected onto a detector located proximate the distal end 214 of the reflector 200. For example, the shape of the exterior wall 202 may be such that light reflects off the exterior wall 202 towards the distal end of the reflector 200.

FIG. 2b shows another embodiment of a reflector 250. The reflector 250 includes an exterior wail 252. The reflector 250 includes interior walls 258a and 258b. The interior walls 258a and 258b and the exterior wall 252 form angles of ten degrees with the vertical axes described above. As shown in FIG. 3, the reflector 200 may have a height h, measured as the distance from the distal end 264 to the proximal end 262. The interior walls 258a and 258b may extend a height less than or equal to h from the distal end 214 of the reflector. For example, as illustrated in FIG. 2b, the interior walls 258a and 258b may have a height of about 0.75 h.

FIG. 2a and FIG. 2b illustrate embodiments of a reflector including two interior walls and four sections, which each have an approximately square cross-section. A reflector may include any number of interior walls and any number of sections. The sections may have any cross-section. For example, a reflector may include one interior wall and two sections. For example, a reflector may include any number of interior walls arranged in a Cartesian grid configuration. For example, a reflector may include any number of interior walls arranged in a polar grid configuration. For example, a reflector may include sections having rectangular, circular, or elliptical cross-sections. In some embodiments, a reflector may not include an interior wall. A reflector may have one interior section. The cross-section of the section may depend on the shape of the exterior wall.

With reference to FIG. 2a, the interior walls 208a and 208b and the inner side 204 of the exterior wall 202 may reflect infrared and optical light. In some embodiments, the interior walls 208a and 208b and the exterior wall 202 may reflect only infrared light. In some embodiments, the interior walls 208a and 208b and the exterior wall 202 may reflect only optical light. In some embodiments, the interior walls 208a and 208b the exterior wall 202 may reflect both infrared light and optical light. In some embodiments, the interior walls 208a and 208b and the exterior wall 202 may reflect some subset of wavelengths within the infrared spectrum or the optical spectrum.

The interior walls 208a and 208b and exterior wall 202 may be made of or coated with a material that reflects at least one of infrared light and optical light. In some embodiments, the entire reflector 200 may be made of a metal such as gold, silver, chrome, copper, aluminum, titanium, nickel, cobalt, chromium, or an alloy of any of the metals listed that reflects infrared and/or optical light. In some embodiments, parts of the reflector 200 may be made of a metal such as gold, silver, chrome, copper, aluminum, titanium, nickel, cobalt, chromium, or an alloy of any of the metals listed that reflects infrared and/or optical light. In some embodiments, the interior walls 208a and 208b and the exterior wall 202 may be coated with a metal such as gold, silver, chrome, copper, aluminum, titanium, nickel, cobalt, chromium, or an alloy of any of the metals listed that reflects infrared and/or optical light. In some embodiments, the metal reflector 200 or the metal coating may be polished. In some embodiments, the interior walls 208a and 208b and the exterior wall 202 may be coated with a pigment or a hybrid pigment that reflects infrared and/or optical light.

FIG. 3 shows a cross-section view of an infrared sensor 350 which includes a reflector 300. The infrared sensor 300 may have a proximal end 354 and a distal end 356. The infrared sensor 300 may include a tube 352. One or more detectors 358a and 358b may be located at the distal end of the tube 352.

The detectors 358a and 358b may detect the wavelength of infrared or optical light. The detectors 358a and 358b may be any type of detector known in the art capable of measuring the wavelength of at least a portion of the infrared and/or optical spectrum. The detectors 358a and 358b may detect the same ranges of wavelengths or may detect different ranges of wavelengths.

The reflector 300 may include an exterior wall 302 and one or more interior walls 308. The interior wall 308 may divide an interior space within the exterior wall 302 of the detector into two or more sections 310a and 310b. The reflector 300 may have a proximal end 312 and a distal end 314. The reflector 300 may be open at both the proximal end 312 and the distal end 314. The exterior wall 302 and the interior wall 308 may taper from a maximum thickness at the distal end 314 of the reflector 300 to a minimum thickness at the proximal end 312 of the reflector 300. The tapered interior wall 308 may form an angle 320 with a vertical axis. The tapered exterior wall 302 may form an acute angle 322 with a vertical axis. The interior wall 308 and the exterior wall 302 may have any shape described above with respect to FIG. 2a and FIG. 2b.

The reflector 302 may be located at the distal end 356 of the tube 352. The distal end 314 of the reflector 302 may be proximate the detectors 358a and 358b. In some embodiments, the number of detectors 358a and 358b included in the infrared sensor 350 may be equal to the number of sections 310a and 310b of the reflector 300. For example, the infrared sensor 350 may include four detectors 358 and the reflector 300 may have four sections 310. The detectors 358a and 358b may be arranged so that each detector 358a and 358b is situated directly proximate a section 310a and 310b of the reflector 300. The area and shape of the detectors 358a and 358b may be about equal to the cross-sectional area and shape of the sections 310a and 310b, respectively. For example, the sections 310 may have an approximately square cross-section. The detectors 358 may have an approximately square shape about the same size as the distal end cross-section of the sections 310.

In some embodiments, the number of detectors 358b and 358b included in the infrared sensor 350 may be less than the number of sections 310a and 310b of the reflector 300. For example, the infrared sensor 350 may include one detector 358 and the reflector 300 may have four sections 310. The detector 358 may be arranged such that a portion of the detector 358 is situated directly proximate every section 310 of the reflector 300. The detector 358 may have an area and shape that is about equal to the cross-section of the exterior wall 302 of the reflector 300. There may not be empty space directly proximate the distal side of any of the sections 310.

The infrared sensor 300 may include a light source (not shown) that emits infrared and/or optical light 360a, 360b, and 360c towards the detectors 358a and 358b. The infrared or optical light 360a, 360b, and 360c may reflect off of the reflective surfaces of the interior wall 308 and the exterior wall 302 of the reflector. The infrared or optical light 360a, 360b, and 360c may be reflected onto the detectors 358a and 358b. The angles that the interior wall 308 and the exterior wall 302 form with a vertical axis may be chosen such that the amount of infrared or optical light 360a, 360b, and 360c that reaches the detectors 358a and 358b is increased compared to a system in which a reflector is not used, and in some embodiments may be maximized.

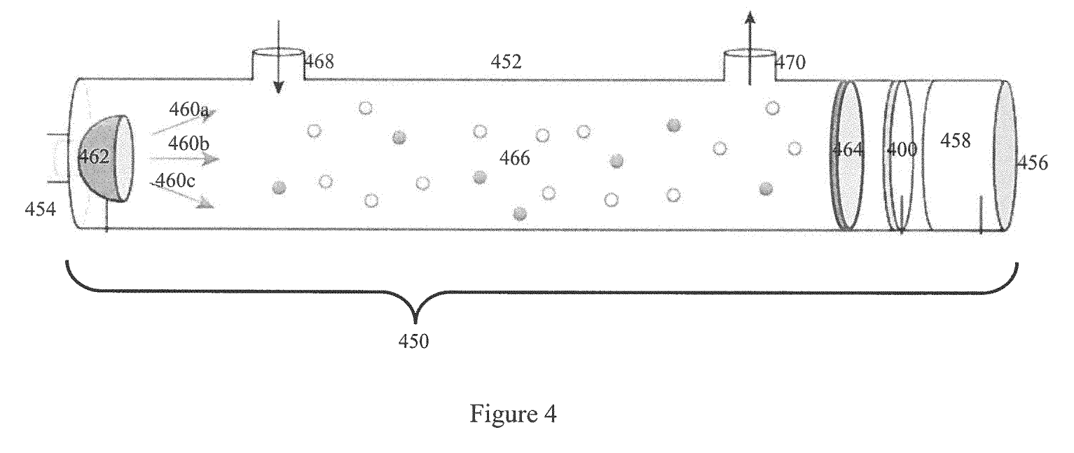

FIG. 4 shows a cross-section view of an infrared sensor 450 including a reflector 400 according to embodiments herein. The infrared sensor 450 may have a proximal end 454 and a distal end 456. The infrared sensor 450 may include a tube 452. An infrared or optical light source 462 may be located within the tube 452 at the proximal end 454 of the infrared sensor 459. One or more detectors 458 may be located within the tube 452 at the distal end 456 of the infrared sensor 450. The reflector 400 may be located within the tube 452 at a distal end 456 of the infrared sensor 450, proximal to the detector 458. The infrared sensor 450 may optionally include an filter 464 which may be located within the tube 452 at the distal end 456 of the infrared sensor 450, proximal to the reflector 400. In some embodiments, as illustrated in FIG. 4, the filter 464 may be proximate the reflector 400. In some embodiments, the filter 464 may be proximate the light source 462. In some embodiments, the filter 464 may be located distal the reflector 400 and proximate both the reflector 400 and the detector 458. A sample chamber 466 may be located within the tube 452, between the light source 462 and the reflector 400. The filter 464 may optionally be located at either end of the sample chamber 466. The sample chamber 466 may include a gas inlet 468 and a gas outlet 470.

In some embodiments, the infrared sensor 450 may include more than one filter 464. The number of filters 464 included in the infrared sensor 450 may be equal to the number of sections 410 of the reflector 400. One filter 464 may be located proximate each section 410 of the reflector 400. The filters 464 may be located proximal or distal to the reflector 400. In this way, light which passes through different sections 410 may be filtered by different filters 464. In some embodiments, the reflector 400 may include grooves, notches, or some other means to hold the filters 464.

The infrared sensor 450 may be used to identify a gas. The gas to be identified may be flowed into the sample chamber 66 through the gas inlet 468. The gas may flow out of the sample chamber 466 through the gas outlet 470. During measurements, a constant amount of gas may be kept within the sample chamber 466 by flowing gas into and out of the chamber at equal rates.

The light source 462 may emit optical or infrared light 460a, 460b, and 460c. The light 460a, 460b, and 460c, may travel through the gas in the sample chamber 466. The gas may absorb some wavelengths of the light while transmitting other wavelengths of the light. Light having the wavelengths that are transmitted may reach detector 458. The detector 458 may measure the wavelength of the light. The measured wavelength may be used to identify the gas. If the infrared sensor 450 includes on filter 464, the filter 464 may filter desired wavelengths of the light to prevent those wavelengths from reaching the detector 458.

The reflector 400 may include reflective surfaces (not shown). The light 460a, 460b, and 460c, may reflect off of the reflective surfaces of the reflector 400 and onto the detector 458. The reflective surfaces of the reflector 400 may be angled in such a way to enhance or maximize the amount of light that reflects off of the reflective surfaces and onto the detector 458. The reflector 400 may increase the total amount of light 360a, 360b, and 360c that reaches the detector 458. In some embodiments, all or almost all light 460a, 460b, and 460c that reflects off of the reflective surfaces of the reflector 400 may reflect onto the detector 458.

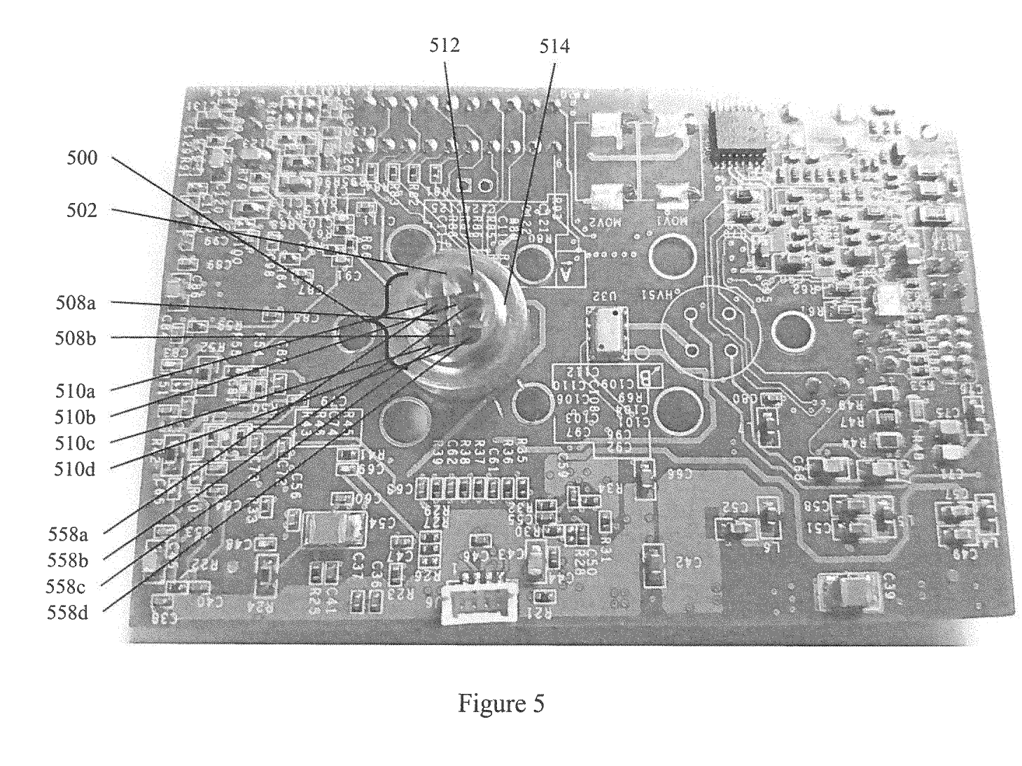

FIG. 5 shows an exemplary reflector 500. The reflector 500 may include an exterior wall 502 and two interior walls 508a and 508b. The interior walls 508a and 508b may divide an interior space within the exterior wall 502 into four sections 510a, 510b, 510c, and 510d. The sections 510a, 510b, 510c, and 510d may have generally square or rectangular cross-sections. The four sections 510a, 510b, 510c, and 510d may have about the same cross-section and cross-sectional area. The reflector 500 may be coated in a material that reflects infrared and/or optical light. In particular, the interior walls 508a and 508b and the exterior wall 502 may be coated in a material that reflects infrared and/or optical light. The material may be gold.

Four detectors 558a, 558b, 558c, and 558d may be located proximate the sections 510a, 510b, 510c, and 510d. The four detectors 558a, 558b, 558c, and 558d may have an approximately square shape. The area and shape of the four detectors 558a, 558b, 558c, and 558d may be similar to the cross-sectional area and cross-section of the four sections 510a, 510b, 510c, and 510d, respectively. Each of the four detectors 558a, 558b, 558c, and 558d may be located proximate one of the four sections 510a, 510b, 510c, and 510d. The four detectors 558a, 558b, 558c, and 558d may detect the wavelength of infrared and/or optical light. The four detectors 558a, 558b, 558c, and 558d may detect infrared and/or optical light of the same range of wavelength or may detect infrared and/or optical light of different ranges of wavelengths.

In some embodiments, the reflector 500 may be assembled and used as part of an infrared sensor. The infrared sensor may include one or more detectors. In some embodiments, the infrared sensor may include four detectors 558a, 558b, 558c, and 558d, as shown in FIG. 5. The reflector 500 may be disposed such that the distal end 514 of the reflector 500 is proximate the detectors 558a, 558b, 558c, and 558d. The reflector 500 may be arranged so that each of four sections 510a, 510b, 510c, and 510d are proximate one of the detectors 558a, 558b, 558c, and 558d. The infrared sensor may also include a light source (not shown) that emits infrared and/or optical light. The light source may be located a distance from the proximate end 512 of the reflector 500. The light source may be arranged such that the light source directs light towards and onto the reflector 500 and the detectors 558a, 558b, 558c, and 558d. The infrared sensor may or may not include a tube (not shown) as described with respect to previous embodiments.

With reference to FIG. 2a, a method of manufacture for a reflector is described. A reflector 200 may be manufactured by machining the reflector 200 from a metal. Any machining technique or tool known in the art may be used to machine the reflector 200. In some embodiments, the metal may be a metal that reflects optical and/or infrared light, such as gold, silver, chrome, copper, aluminum, titanium, nickel, cobalt, chromium, or an alloy of any of the metals listed. In some embodiments, the metal may be a metal that does not reflect optical and/or infrared light. All or part of the reflector 200, including at least the interior walls 208a and 208b and the exterior wall 202 may be coated with a material that reflects infrared and/or optical light. The material may be a metal such as gold, silver, chrome, copper, aluminum, titanium, nickel, cobalt, chromium, or an alloy of any of the metals listed. The reflector 200 may be coated with the metal using a sputter coater. The material may be a pigment. The reflector 200 may be soaked in the pigment or the pigment may be painted onto the reflector 200.

A reflector 200 may be manufactured by molding the reflector 200 from a plastic, resin, or other material. A mold for the reflector 200 may be made of a metal or other material suitable for making a mold. Reflectors 200 may then be cast in the mold. Any material known in the art may be used to make the reflector 200. The material used to make the reflector 200 may not reflect optical and/or infrared light. All or part of the reflector 200, including at least the interior walls 208a and 208b and the exterior wall 202 may be coated with a material that reflects infrared and/or optical light. The material may be a metal such as gold, silver, chrome, copper, aluminum, titanium, nickel, cobalt, chromium, or an alloy of any of the metals listed. The reflector 200 may be coated with the metal using a sputter coater. The material may be a pigment. The reflector 200 may be soaked in the pigment or the pigment may be painted onto the reflector 200.

With reference to FIG. 3, a method for the manufacture of an infrared sensor 350 is described. A reflector 300 may be manufactured according to the method described above. One or more detectors 358a and 358b may be arranged proximate the sections 310a and 310b of the reflector 300. The number of detectors 358a and 358b may be equal to the number of sections 310a and 310b. The detectors 358a arid 358b may be arranged such that one detector 358a and 358b is proximate each of the sections 310a and 310b. The reflector 300 and the detectors 358a and 358b may be placed at a distal end 356 of a tube 352. A light source (not shown) may disposed at a proximal end 354 of the tube 352.

In some embodiments of the method, an infrared sensor 350 may be retrofit to include a reflector 300. One or more detectors 358a and 358b may already be disposed within a tube 352 at a distal end 356 of the infrared sensor 350. The reflector 300 may be inserted into the tube 352 of the infrared sensor 350 and disposed adjacent and proximal to the detectors 358a and 358b. The tube 352 may be machined to include grooves, notches, or any means known in the art to hold the reflector 300 in the desired position. The detectors may be removed from the tube 352 prior to insertion of the reflector 300 and reinserted after insertion of the reflector 300. The reflector 300 may be arranged such that each section 310a and 310b of the reflector 300 is proximate a detector 358a and 358b.

In some embodiments of the method, an infrared sensor 350 may be assembled by arranging a reflector 300 proximate one or more detectors 358a and 358b, such that each section 310a and 310b of the reflector 300 is proximate a detector 358a and 358b. A tube 352 may be disposed such that a distal end 356 of the tube surrounds the reflector 300 and the detectors 358a and 358b. A light source (not shown) may be inserted into a proximal end 354 of the tube, either before or after the tube 352 is disposed over the reflector 300. One or more filters (not shown) may be disposed within the infrared sensor 350 in any configuration described previously.

The reflector of the present disclosure and the infrared sensor of the present disclosure may have advantages in making wavelength measurements. An infrared sensor including the reflector of the present disclosure may have advantages over an infrared sensor not including a reflector.

For a detector to detect the presence of light having a target wavelength, the light having the target wavelength must contact the surface of the detector. The amount of light of the target wavelength that contacts the surface of the detector correlates directly to the strength of the signal detected by the detector. In other words, if more light of the target wavelength that contacts the surface of the detector, the signal detected by the detector will be larger. The detector will also detect light having wavelengths other than the target wavelength. This will be measured as noise. The larger the signal is, the greater the signal-to-noise ratio is. A greater signal-to-noise ratio allows the detector to make more accurate measurements.

The reflector of the present disclosure may increase the amount of light of a target wavelength which contacts the detectors of an infrared sensor. In infrared sensors without a reflector, some light of the target wavelength will contact the area between the detectors and will not be measured. It may be necessary to maintain space between the detectors to prevent cross-talk between the detectors. The reflector may be arranged in front of the detectors such that light which would have contacted the space between the detectors instead contacts the reflector. The inner walls and the interior side of the exterior wall of the reflector may be angled such that the light reflects off of the reflector and onto one of the detectors. In this way, the amount of light, including light of the target wavelength, contacting the detector, may be increased.

The reflector of the present disclosure may enable an infrared sensor to include multiple detectors without sacrificing the ability to measure light that may contact the area between the detectors, instead of the detectors. This may enable detectors that measure multiple ranges of wavelengths to be used in a single infrared sensor without loss of measurement capabilities of the infrared sensor. Including a reflector in an infrared sensor may enable the infrared sensor to use smaller detectors without losing measurement capabilities.

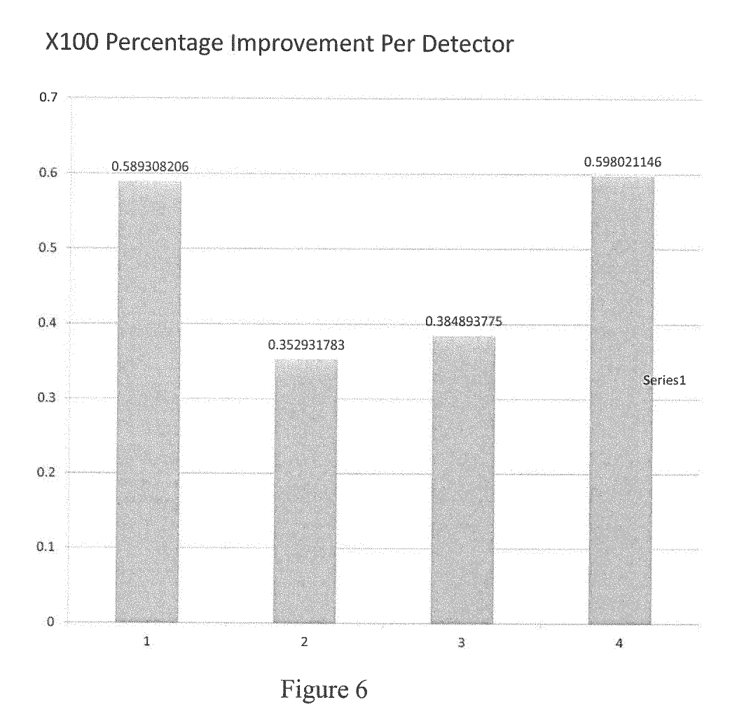

FIG. 6 shows experimental data comparing signals measured by an infrared sensor without a reflector and signals measured by the same infrared sensor when a reflector was added. The infrared sensor used is shown in FIG. 5. The infrared sensor includes four detectors. The reflector is made of aluminum and coated in gold. There is a distance of 1 mm separating each detector from the other proximate detectors. The light source (not shown) is a miniature infrared light bulb. Each of the four detectors is capable of measuring wavelengths from 700 nanometers to 15000 nanometers. In FIG. 6, the four detectors are displayed along the x-axis of the graph. The percent increase in signal measured when the reflector was added to the infrared sensor is shown on the y-axis. As the graph illustrates, the signal measured by each of the detectors increased by at least thirty five percent when the reflector was added proximate the detectors.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed is:

1. A reflector comprising:
an exterior wall;
an interior space;
one or more interior walls, each interior wall having two ends;
a proximal end; and
a distal end,
wherein each end of an interior wall is attached to the exterior wall or to a different interior wall,
wherein the interior walls divide the interior space into two or more sections,
wherein the proximal end and the distal end of the reflector are open, and
wherein the exterior wall and the interior walls are configured to reflect light that contacts the exterior wall or interior walls through the distal end of the reflector.

2. The reflector of claim 1, wherein the exterior wall is cylindrical.

3. The reflector of claim 2, comprising two interior walls which at a right angle, and comprising four sections, wherein the cross-section of each section is approximately square.

4. The reflector of claim 1, wherein the reflector is made of plastic or metal.

5. The reflector of claim 1, wherein the interior walls and the exterior wall are coated with a material that reflects at least one of optical waves and infrared waves.

6. The reflector of claim 5, wherein the reflective material is gold, silver, chrome, copper, aluminum, titanium, nickel, cobalt, chromium, or alloys thereof.

7. The reflector of claim 1, wherein the interior walls and the exterior wall are tapered from a maximum thickness at the distal end of the reflector to a minimum thickness at the proximal end of the reflector.

8. The reflector of claim 7, wherein interior walls and the exterior wall are tapered at an angle between five degrees and 20 degrees.

9. The reflector of claim 7, wherein the tapered portion of at least one of the interior walls and the exterior wail includes a concave curve.

10. The reflector of claim 1, wherein a cross-section of each of the sections at the distal end of the reflector is approximately a square.

11. An infrared device comprising:
a tube having a proximal end and a distal end;
a light source disposed at the proximal end of the tube;
one or more detectors disposed at the distal end of the tube;
a filter disposed between the light source and the one or more detectors; and
a reflector comprising:
an exterior wall;
an interior space;
one or more interior walls, each interior wall having two ends;
a proximal end; and
a distal end,
wherein each end of an interior wall is attached to the exterior wall or to a different interior wall,
wherein the interior walls divide the interior space into two or more sections,
wherein the exterior wall is open at the proximal end and the distal end of the reflector, and
wherein the exterior wall and the interior walls are configured to reflect light that contacts the exterior wall or interior walls through the distal end of the reflector,
wherein the distal end of the reflector is disposed proximate the one or more detectors.

12. The infrared device of claim 11, wherein the number of detectors is equal to the number of sections and the detectors are arranged such that each detector is proximate a distal end of one section of the reflector.

13. The infrared device of claim 11, wherein the interior walls and the exterior wall are tapered from a maximum thickness at the distal end of the reflector to a minimum thickness at the proximal end of the reflector.

14. The infrared device of claim 11, wherein interior walls and the inner sides of the exterior wall are angled inward at an angle between five degrees and twenty degrees.

15. The infrared device of claim 11, the shape and area of the detectors is similar to the cross-section and cross-sectional area of the sections, respectively.

16. A method of constructing an infrared device, comprising:
disposing a reflector intermediate a light source and one or more detectors, the reflector comprising:
an exterior wall;
an interior space;
one or more interior walls, each interior wall having two ends;
a proximal end; and
a distal end,
wherein each end of an interior wall is attached to the exterior wall or to a different interior wall,
wherein the interior walls divide the interior space into two or more sections, and
wherein the exterior wall is open at the proximal end and the distal end of the reflector, and
wherein the exterior wall and the interior walls are configured to reflect light that contacts the exterior wall or interior walls through the distal end of the reflector,
wherein the distal end of the reflector is proximate the one or more detectors.

17. The method of claim 16, wherein the number of detectors is equal to the number of sections and the detectors are arranged such that each detector is proximate a distal end of one section of the reflector.

18. The method of claim 16, further comprising disposing a tube around the reflector, the one or more detectors, and the light source, such that the reflector and the one or more detectors are located at a distal end of the tube and the light source is located at a proximate end of the tube.

19. The method of claim 18, wherein the outer diameter of the reflector is approximately equal to the inner diameter of the tube.

20. The method of claim 16, wherein the interior walls and the exterior wall of the reflector are tapered from a maximum thickness at the distal end of the reflector to a minimum thickness at the proximal end of the reflector.
